(19) United States
(12) Patent Application Publication
(10) Pub. No.: US 2026/0033695 A1
(43) Pub. Date: Feb. 5, 2026

(54) CLEANING DEVICE AND CLEANING SYSTEM

(71) Applicant: Beijing Roborock Technology Co., Ltd., Changping District, Beijing (CN)

(72) Inventors: Xing LI, Changping District, Beijing (CN); Yongfei ZHOU, Changping District, Beijing (CN); Cheng YANG, Changping District, Beijing (CN)

(73) Assignee: Beijing Roborock Technology Co., Ltd., Changping District, Beijing (CN)

(21) Appl. No.: 18/998,979

(22) PCT Filed: Mar. 29, 2023
(86) PCT No.: PCT/CN2023/084661

§ 371 Date: Jan. 27, 2025

(30) Foreign Application Priority Data
Jul. 28, 2022 (CN) 202210904357.7
Jul. 28, 2022 (CN) 202221975470.6

(51) Int. Cl. A47L 11/40; A47L 11/30; B01F 23/451; B01F 25/31; B01F 35/71; B01F 101/00; B01F 101/24

(52) U.S. Cl. CPC A47L 11/4088; A47L 11/302; A47L 11/4041; A47L 11/4083; B01F 23/451; B01F 25/31; B01F 35/714; B01F 35/717611; B01F 2101/24; B01F 2101/4505

(57) ABSTRACT

A cleaning device and a cleaning system. The cleaning device includes: a cleaning base provided with a cleaning roller, the cleaning base being configured to move on a surface to be cleaned so that the cleaning roller cleans the surface to be cleaned; a clear water tank configured to contain clear water; a detergent box configured to contain a detergent; and a dual-head pump configured to pump a first liquid and a second liquid and including: a driving motor; a first pump body mounted on a first side of the driving motor and configured to pump the first liquid; and a second pump body mounted on a second side of the driving motor and configured to pump the second liquid, the first side and the second side being arranged opposite to each other.

### CROSS-REFERENCE TO RELATED APPLICATIONS

The present application is a U.S. National Stage of International Application No. PCT/CN2023/084661, filed on Mar. 29, 2023, which claims priorities to the Chinese Patent Application No. 202210904357.7 filed on Jul. 28, 2022 and the Chinese Patent Application No. 202221975470.6 filed on Jul. 28, 2022, all of which are incorporated herein by reference in their entireties as a part of the present disclosure.

### TECHNICAL FIELD

The present disclosure relates to the technical field of automatic cleaning, and in particular to a cleaning apparatus and system.

### BACKGROUND

With the continuous development of technologies, cleaning apparatuses such as floor scrubbers have been widely used in households since they are more time-saving and labor-saving than traditional manual cleaning. A floor scrubber generally includes an apparatus body and a cleaning base. The apparatus body is generally provided with a waste water tank and a clean water tank, as well as a main fan for suction. The cleaning base includes a cleaning roller for mopping, and a cleaning liquid. For example, water is sprayed onto the cleaning roller through a built-in water tube, and the cleaning roller rotates at high speed to mop the floor.

### SUMMARY

According to some embodiments of the present disclosure, a cleaning apparatus is provided. The cleaning apparatus includes:
a cleaning base provided with a cleaning roller, the cleaning base being configured to move on a surface to be cleaned to enable the cleaning roller to clean the surface to be cleaned;
a clean water tank configured to accommodate clean water;
a detergent tank configured to accommodate a detergent; and
a dual-head pump configured to pump a first liquid and a second liquid, the dual-head pump including:
a first pump body configured to pump the first liquid,
a second pump body configured to pump the second liquid, and
a drive motor for driving the first pump body and the second pump body.

According to some embodiments of the present disclosure, a cleaning system is provided. The cleaning system includes:
the cleaning apparatus described in the foregoing embodiments; and
a station configured to support the cleaning apparatus.

### BRIEF DESCRIPTION OF DRAWINGS

The accompanying drawings, which are incorporated in and constitute part of the Description, show embodiments conforming to the present disclosure and serve to explain the principles of the present disclosure together with the Description. Apparently, the accompanying drawings in the following description show merely some embodiments of the present disclosure, and those of ordinary skill in the art can still derive other drawings from these accompanying drawings without creative efforts. In the accompanying drawings:

FIG. 1 is a schematic structural diagram of a cleaning apparatus provided according to some embodiments of the present disclosure;

FIG. 2 is a schematic structural diagram of a cleaning base provided according to some embodiments of the present disclosure, without showing an upper cover and a detergent tank;

FIG. 3 is a schematic structural diagram of a dual-head pump provided according to some embodiments of the present disclosure;

FIG. 4 is a schematic structural diagram of a mixing tube provided according to some embodiments of the present disclosure;

FIG. 5 is a partially schematic structural diagram of an apparatus body provided according to some embodiments of the present disclosure;

FIG. 6 is a schematic structural diagram of a clean water tank provided according to some embodiments of the present disclosure;

FIG. 7 is a schematic structural diagram of a clean water tank provided according to some embodiments of the present disclosure; and

FIG. 8 is a schematic structural diagram of a cleaning system provided according to some embodiments of the present embodiment.

### DETAILED DESCRIPTION

To make the objectives, technical solutions and advantages of the present disclosure clearer, the present disclosure will be further described in detail below with reference to the accompanying drawings. Obviously, the described embodiments are only some but not all of the embodiments of the present disclosure. All other embodiments obtained by those of ordinary skill in the art based on the embodiments in the present disclosure without creative efforts shall fall within the protection scope of the present disclosure.

It should also be noted that the terms “including”, “containing” or any other variants thereof are intended to cover the nonexclusive inclusion, such that a commodity or device including a series of elements includes not only those elements, but also other elements not listed explicitly or elements inherent to such a commodity or device. Without more limitations, the element defined by the phrase “including a . . . ” does not exclude the existence of other identical elements in the commodity or apparatus including the element.

In this field, a cleaning apparatus (e.g., a floor scrubber) generally includes an apparatus body and a cleaning base. The apparatus body generally has a waste water tank and a clean water tank, as well as a main fan for suction. The cleaning base includes a cleaning roller for mopping, and the number of the cleaning roller(s) is one, two or more. A cleaning liquid is sprayed through a built-in water tube to the fluffy cleaning roller and/or a surface to be cleaned. The cleaning roller rotates at high speed to mop the floor. Meanwhile, the main fan forms a negative pressure in an air duct of the cleaning apparatus to suck in waste water (which may contain solid wastes) on the surface to be cleaned from a suction port of the cleaning apparatus, and the waste water is pumped into a waste water tank.

The cleaning liquid may be a mixture of water and a detergent. In some related arts, the detergent needs to be manually added to the clean water by a user, making it difficult to control the ratio of the clean water to the detergent. Consequently, the content of the detergent in the mixed cleaning liquid may be too low to achieve the effect of cleaning, or the content of detergent in the mixed cleaning liquid may be too high, which leads to the waste of detergent. In some other related arts, the cleaning apparatus is provided with a detergent tank for accommodating the detergent and a mixing container for mixing the clean water and the detergent. Both the clean water and the detergent need to be pumped to the mixing container for mixing; the mixing container may have a relatively large volume; and the clean water and the detergent need two pumping devices that are driven by different motors, respectively, resulting in complex structure and high cost.

The present disclosure provides a cleaning apparatus. The cleaning apparatus includes a cleaning base provided with a cleaning roller; a clean water tank configured to accommodate clean water; a detergent tank configured to accommodate a detergent; and a dual-head pump, including a drive motor; a first pump body mounted on a first side of the drive motor and configured to pump the clean water, and a second pump body mounted on a second side of the drive motor and configured to pump the detergent, the first side being provided opposite to the second side. The dual-head pump is configured to pump the clean water and the detergent, and integrates one motor and the first and second pump bodies located on both sides of the motor, respectively, such that liquids in two paths can be pumped at the same time, which simplifies the structure, saves the space and reduces the cost.

Some embodiments of the present disclosure will be described below in detail with reference to the accompanying drawings.

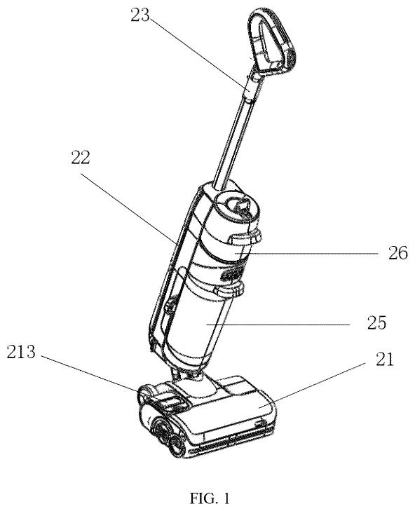

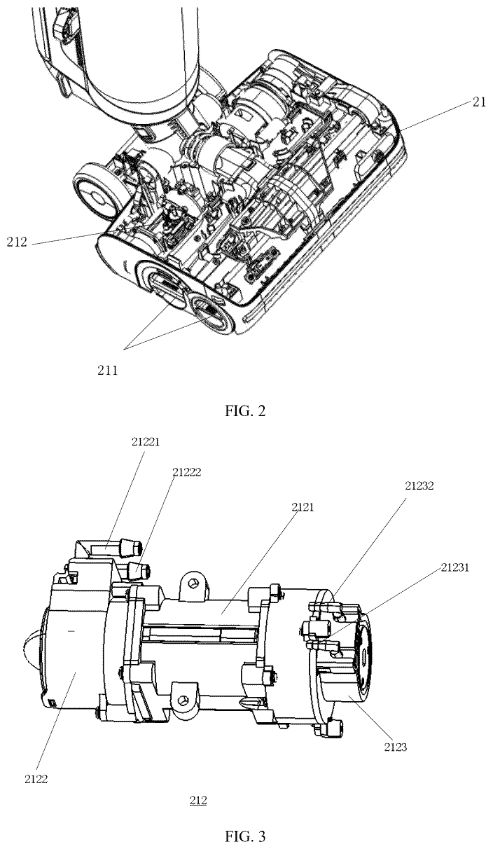

FIG. 1 is a schematic structural diagram of a cleaning apparatus provided according to some embodiments of the present disclosure. FIG. 2 is a schematic structural diagram of a cleaning base provided according to some embodiments of the present disclosure, without showing an upper cover and a detergent tank. FIG. 3 is a schematic structural diagram of a dual-head pump provided according to some embodiments of the present disclosure.

As shown in FIG. 1 to FIG. 3, a cleaning apparatus 20, for example, a floor scrubber, is provided according to some embodiments of the present disclosure. The cleaning apparatus 20 includes a cleaning base 21, an apparatus body 22 and a handle assembly 23. The apparatus body 22 is provided above the cleaning base 21 and is movably connected (e.g., pivoted) to the cleaning base 21. The handle assembly 23 is connected to one end of the apparatus body 22 distal from the cleaning base 21, and allows a user to hold in operation. The user holds the handle assembly 23 to control the cleaning base 21 to perform a cleaning task on a surface to be cleaned, for example, on the floor.

In some embodiments, the apparatus body 22 extends longitudinally. The handle assembly 23 is connected to the upper end of the apparatus body 22, and the cleaning base 21 is connected to the lower end of the apparatus body 22. The apparatus body 22 is pivotally connected to the cleaning base 21, such that the handle assembly 23 and the apparatus body 22 can rotate relative to the cleaning base 21, thereby enabling to change the operating angle and flexibly adjust the cleaning posture. The cleaning base 21 is provided with a cleaning component, for example, a cleaning roller 211, which is located at the bottom. Specifically, for example, the number of the cleaning roller(s) 211 is one or more, for example, two, and the cleaning roller 211 is rotatable at high speed to mop the floor.

The cleaning apparatus further includes a liquid supply system. The liquid supply system includes a liquid storage device, a liquid supply tube, a power source for liquid supply, and a liquid dispenser. The liquid storage device is configured to store a cleaning liquid and may be implemented as one, two or more containers, or a container having more than two chambers therein, or their combination. The power source for liquid supply is a device that provides power for the flow of cleaning fluid, for example, a water pump. The liquid dispenser is a device that dispenses the cleaning liquid to a cleaning roller brush and/or the surface to be cleaned. The liquid supply tube is a tube through which the cleaning liquid flows from the liquid storage device to the liquid dispenser under the power provided by the power source for liquid supply.

In some embodiments, the liquid storage device has more than two containers or chambers, among which at least one container or chamber is configured to accommodate the clean water, and the remaining containers or chambers are configured to accommodate the detergent or other solvents for enhancing the cleaning effect.

In some embodiments, the cleaning apparatus 20 (e.g., a floor scrubber) further includes a clean water tank 26 and a waste water tank 25, both of which are, for example, detachably mounted on the apparatus body 22. The clean water tank 26 is configured to accommodate a cleaning liquid. The cleaning liquid may be the clean water or the mixture of clean water and detergent. The clean water may be directly dispensed through a liquid dispenser to the cleaning roller 21 and/or the surface to be cleaned, for the purpose of wetting the surface of the cleaning roller 211, such that the wetted cleaning roller 211 can perform wet cleaning on the surface to be cleaned. The clean water may also, after being pumped out of the clean water tank, mixed with the detergent into a cleaning liquid; and then the mixture is supplied through the liquid dispenser to the cleaning roller 21 and/or the surface to be cleaned, for the purpose of wetting the surface of the cleaning roller 211, such that the wetted cleaning roller 211 can perform wet cleaning on the surface to be cleaned. The waste water tank 25 is configured to accommodate waste water that is collected. When the cleaning roller 211 performs the wet cleaning, waste water is generated on the cleaned surface, and may be collected into the waste water tank 25 through a waste water collecting tube.

In some embodiments, the cleaning apparatus 20 further includes a detergent tank 213. For example, the detergent tank 213 is provided on the cleaning base 21 and is configured to accommodate the detergent.

The cleaning apparatus 20 further includes a dual-head pump 212 as a power source for liquid supply, and is configured to pump two types of liquids, namely a first liquid and a second liquid, and the two liquids are any two of the following: the clean water, the detergent, and a mixture of the clean water and the detergent. Specifically, the dual-head pump includes a drive motor 2121 and a first pump body 2122 and a second pump body 2123 provided on both sides of the drive motor 2121. For example, the first pump body 2122 is mounted on a first side (e.g., the left side shown in FIG. 3) of the drive motor 2121, and is configured to pump the first liquid. For example, the second pump body 2123 is mounted on a second side (e.g., the right side shown in FIG. 3) of the drive motor 2121, and is configured to pump the second liquid.

In the above embodiment, the drive motor 2121, the first pump body 2122 and the second pump body 2123 are integrated into an integral structure, with one drive motor driving the two pump bodies at the same time. Compared with the solution in the related art that two motors are configured to drive two pumping devices respectively, the solution in the present disclosure has a simple structure, a smaller space and a reduced number of drive motors, such that the cost is reduced.

In the above embodiment, the first pump body and the second pump body are located on two sides of the drive motor, respectively, and for example, are both peristaltic pumps. In other embodiments, the first pump body and the second pump body may also be located on the same side of the drive motor, may also take the form of other pumping devices, such as electromagnetic pumps, diaphragm pumps, gear pumps, screw pumps, vane pumps and water ring pumps. The first pump body and the second pump body may be the same or different.

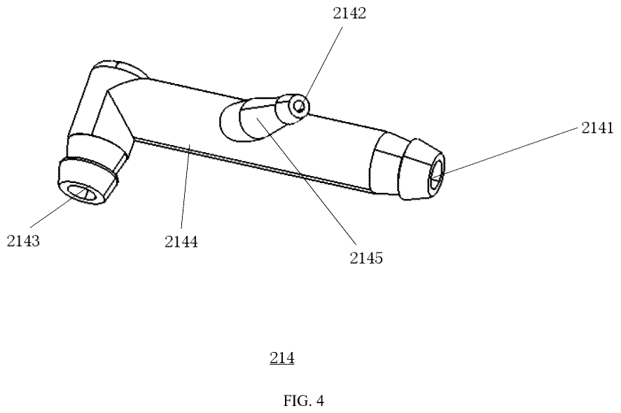

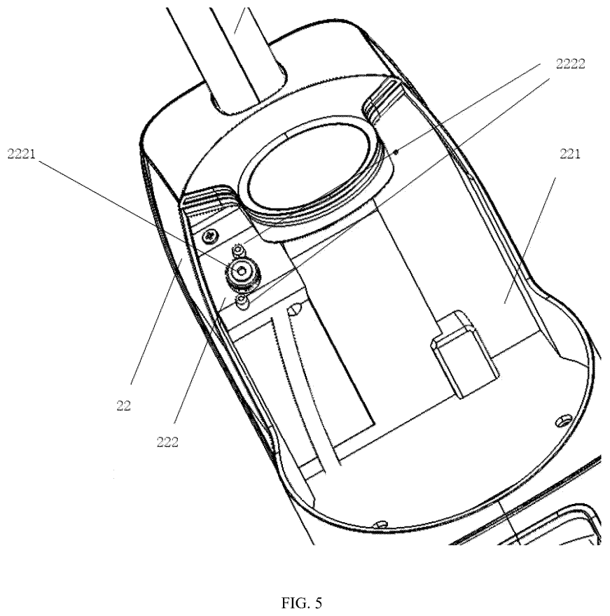

FIG. 4 is a schematic structural diagram of a mixing tube provided according to some embodiments of the present disclosure. In conjunction with FIG. 1 to FIG. 4, the liquid supply tube in the cleaning apparatus 20 includes a mixing tube 214. For example, the mixing tube 214 is also provided in the cleaning base 21. The mixing tube 214 includes a first inlet 2141, a second inlet 2142 and a mixed liquid outlet 2143, and is configured to mix a liquid entering the first inlet 2141 and a liquid entering the second inlet 2142 to produce a mixed liquid and output the mixed liquid. The mixed liquid may be a first liquid or a second liquid input into the first pump body 2122 or the second pump body 2123, and may also be a cleaning liquid dispensed through the liquid dispenser to the cleaning roller 211 and/or the surface to be cleaned. In the case that the mixed liquid is the cleaning liquid, the mixed liquid outlet 2143 is a cleaning liquid outlet.

In some embodiments, as shown in FIGS. 3 and 4, the first pump body 2122 includes a first pump inlet 21221 and a first pump outlet 21222. The first pump inlet 21221 is connected to the clean water tank 26 through a clean water tube, and the first pump outlet 21222 is connected to the mixing tube 214 through a transport tube. Under the driving of the drive motor 2121, the first pump body 2122 pumps the clean water from the clean water tank 26 to the mixing tube 214. The first pump body 2122 is, for example, a peristaltic pump, which can pump the clean water evenly. The second pump body 2123 includes a second pump inlet 21231 and a second pump outlet 21232. The second pump inlet 21231 is connected to the detergent tank 213 through a detergent tube, and the second pump outlet 21232 is connected to a subsequently introduced mixing tube 214 through a transport tube. Under the driving of the drive motor 2121, the second pump body 2123 pumps the detergent from the detergent tank 213 to the mixing tube 214. The second pump body 2123 is, for example, a peristaltic pump, which can pump the detergent evenly.

As shown in FIG. 4, the mixing tube 214 includes the first inlet 2141, the second inlet 2142 and the mixed liquid outlet 2143. The first inlet 2141 is communicated with the first pump outlet 21222 of the first pump body 2122 through a transport tube. Under the action of the first pump body 2122, the first liquid enters the mixing tube 214 from the first inlet 2141. The second inlet 2142 is communicated with the second pump outlet 21232 of the second pump body 2123. Under the action of the second pump body 2123, the second liquid enters the mixing tube 214 from the second inlet 2142. The first liquid and the second liquid are mixed into a cleaning liquid in the mixing tube 214, and then, the cleaning liquid is output from the mixed liquid outlet 2143. The mixed liquid outlet 2143 is communicated with a liquid dispensing port near the cleaning roller 211 through, for example, the transport tube; and the cleaning liquid is dispensed to the cleaning roller 211 and/or the surface to be cleaned for wet cleaning.

In some embodiments, as shown in FIGS. 3 and 4, the first pump body 2122 further includes a first pump inlet 21221 and a first pump outlet 21222. The second pump body 2123 further includes a second pump inlet 21231 and a second pump outlet 21232. The second pump inlet 21231 is connected to the detergent tank 213 through a detergent tube. The second pump outlet 21232 is connected to the mixing tube 214 through a transport tube. The mixing tube 214 includes the first inlet 2141, the second inlet 2142 and the mixed liquid outlet 2143. The second inlet 2142 is connected to the second pump outlet 21232 through a transport tube; the first inlet 2141 is connected to the clean water tank 26 through a clean water tube; the mixed liquid outlet 2143 is connected to the first pump inlet 21221; and the first pump outlet 21222 is communicated with the liquid dispensing port near the cleaning roller 211 through, for example, a transport tube. The second pump body 2123 pumps the detergent out of the detergent tank 213 and feeds the detergent into the mixing tube 214 to be mixed with the clean water. The mixed cleaning liquid is pumped out by the first pump body 2122 and then dispensed to the cleaning roller 211 and/or the surface to be cleaned, for wet cleaning. By advancing a mixing process to the inlet of the pump body, the problem that the clean water enters the detergent tank due to a capillary effect is avoided for the solution that liquids are output by two pump bodies and then mixed.

In some embodiments, as shown in FIG. 4, the mixing tube 214 includes a main tube 2144 and a branch tube 2145, and the tube diameter of the branch tube 2145 is smaller than that of the main tube 2144. The first inlet 2141 and the mixed liquid outlet 2143 are provided at two opposite ends of the main tube 2144, respectively, and the liquid entering from the first inlet 2141 flows along the main tube 2144 to the mixed liquid outlet 2143. In some embodiments, the main tube 2144 is in the form of, for example, a straight line, a zigzag, a curved line or the like.

The second inlet 2142 is provided at the end of the branch tube 2145 distal from the main tube 2144, and the other end of the branch tube 2145 is connected to the main tube 2144. As shown in FIG. 4, the branch tube 2145 extends from the side wall of the main tube 2144 in a direction inclined to the extension direction of the main tube 2144. For example, an obtuse angle exists between the extension direction of the branch tube 2145 and the flow direction of the clean water in the main tube 2144. Under the action of the second pump body 2123, the liquid entering from the second inlet 2142 flows into the main tube 2144 along the branch tube 2145. The branch tube 2145 and the main tube 2144 are inclined to each other. When the liquid flows through the branch tube 2145 and enters the main tube 2144, its flow direction intersects with the flow direction of the liquid in the main tube 2144, such that the liquid in the branch tube can be better mixed into the liquid in the main tube to quickly form a mixed liquid. In other embodiments, the extension direction of the branch tube 2145 and the flow direction of the liquid in the main tube 2144 may also be perpendicular to each other or have an acute angle therebetween.

In some embodiments, the first liquid and the second liquid are mixed in the mixing tube 214 at a fixed ratio. By using the same drive motor to simultaneously drive the first pump body 2122 and the second pump body 2123 with uniform output, the first pump body 2122 and the second pump body 2123 pump out the first and second liquids stably and uniformly at their flow rates set separately, respectively, thereby ensuring that the mixing ratio of the clean water to the detergent in the mixing tube 214 is fixed. This ratio may be preset such that an optimal cleaning effect can be achieved while the amount of the detergent used can be reduced. Compared with the solution in which the mixing ratio of the detergent to the clean water is controlled by a user himself/herself, the solution in the present disclosure can improve the utilization ratio of the detergent to achieve a high-quality and stable cleaning effect.

In some embodiments, the liquid-pumping flow rate of at least one of the first pump body 2122 and the second pump body 2123 is adjustable, and the mixing ratio of the clean water to the detergent can be adjusted based on the adjustment of the liquid-pumping flow rate. For example, the liquid-pumping flow rate(s) of the first pump body 2122 and/or the second pump body 2123 may be adjusted by adjusting a supply voltage. Here, adjusting the supply voltage may refer to adjusting the frequency, amplitude, or both frequency and amplitude of the voltage. The liquid-pumping flow rate may be functional of the supply voltage, for example, the liquid-pumping flow rate may be linearly related to the supply voltage.

In some embodiments, for example, the pump body (i.e., the first pump body 2122 and/or the second pump body 2123) is a procured device with a predetermined adjustable range of rated supply voltage, and the adjustable range of the liquid-pumping flow rate is also predetermined. When the demand flow of liquid supply is within the adjustable range of the liquid-pumping flow rate of the pump body, the liquid-pumping flow rate of the pump body can be adjusted by adjusting the supply voltage to meet the demand flow rate of liquid supply.

In some embodiments, in some operating modes, when the demand flow rate of liquid supply is not within the adjustable range of the liquid-pumping flow rate of the pump body and is lower than the minimum liquid-pumping flow rate of the pump body, an intermittent operating strategy may be employed for the pump body to meet the demand flow rate of liquid supply. That is, the pump body is controlled to pump the liquid at interval. Specifically, the intermittent operation of the pump body may be achieved by powering on/off the pump body to allow a mean flow rate over a period of time to meet the demand flow rate of liquid supply. For example, in a case where the demand flow rate of liquid supply is 1 ml/s but the minimum flow rate of adjustable pumping during operating of the pump body is 2 ml/s, the pump may be adjusted to the minimum flow rate, and then, the intermittent pumping strategy of operating for 1 s and stopping for 1 s may be employed to achieve a mean flow rate of 1 ml/s in a cycle of 2s, thereby meeting the demand flow rate of liquid supply.

In some embodiments, as shown in FIG. 1 to FIG. 4, the dual-head pump 212 is provided in the cleaning base 21. Specifically, the detergent tank 213 is provided in the cleaning base 21, the dual-head pump 212 is provided between the detergent tank 213 and the bottom surface of the cleaning base 21, and the detergent tank substantially covers the dual-head pump 212.

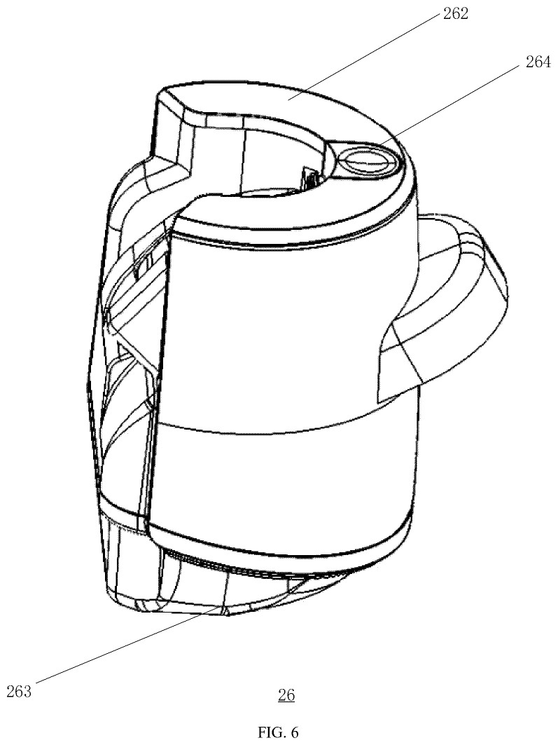

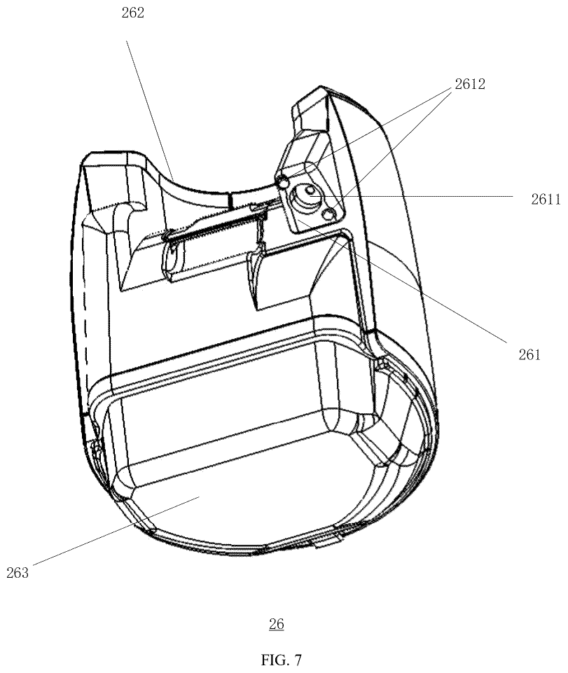

FIG. 5 is a partial schematic structural diagram of an apparatus body provided according to some embodiments of the present disclosure. FIG. 6 is a schematic structural diagram of a clean water tank provided according to some embodiments of the present disclosure. FIG. 7 is a schematic structural diagram of a clean water tank provided according to some embodiments of the present disclosure. The clean water tank in FIG. 7 is shown in a different angle of view than that in FIG. 6.

In some embodiments, as shown in FIG. 1 to FIG. 7, the cleaning apparatus 20 includes an apparatus body 22 that is pivoted to the cleaning base 21. For example, the apparatus body 22 and the cleaning base 21 are in a universal pivot joint. The apparatus body 22 has a mounting groove 221, in which the clean water tank 26 is detachably mounted. The mounting groove 221 has a mounting surface 222, on which a first clean water interface part 2221 and at least one first positioning part 2222 are provided. The first clean water interface part 2221 serves as the water inlet of a clean water delivery tube inside the cleaning apparatus 20, and the clean water delivery tube is a tube for transporting the clean water and forms at least a part of the liquid supply tube.

The clean water tank 26 has an interface surface 261, which corresponds to the mounting surface 222 of the mounting groove 221. For example, when the clean water tank 26 is mounted in the mounting groove 221, the mounting surface 222 substantially conforms to the interface surface 261.

In some embodiments, as shown in FIG. 1 to FIG. 7, the interface surface 261 is provided with a second clean water interface part 2611 and at least one second positioning part 2612, and the second clean water interface part 2611 is the water outlet of the clean water tank 26. When the clean water tank 26 is mounted in the mounting groove 221, the first clean water interface part 2221 is matched and docked with the second clean water interface part 2611, such that the clean water delivery tube in the apparatus body 22 is connected to the water outlet of the clean water tank 26. The first positioning part 2222 is matched and docked with the second positioning part 2612, such that the clean water tank 26 is firmly mounted in the mounting groove 221, thereby preventing the clean water tank 26 from shaking relative to the apparatus body 22. Moreover, the process of matching and interfacing the first positioning part 2222 and the second positioning part 2612 can assist in quickly identifying the mounting position of the clean water tank 26.

In some examples, one of the first clean water interface part 2221 and the second clean water interface part 2611 is a clean water connector, and the other thereof is a clean water interface groove. For example, as shown in FIG. 1 to FIG. 7, the first clean water interface part 2221 is the clean water connector which extends from the mounting surface 222 and extends away from the mounting surface 222. For example, the clean water connector extends from the mounting surface 222 and extends away from the mounting surface 222 in a direction substantially perpendicular to the mounting surface 222. The second clean water interface part 2611 is the clean water interface groove provided on the interface surface 261, and concaves from the interface surface 261 to the interior of the clean water tank 26. For example, the outlet of the clean water tank 26 is provided on the bottom of the clean water interface groove. The clean water connector and the clean water interface groove match each other in shape and size. When the clean water tank 26 is mounted in the mounting groove 221, the clean water connector is inserted into the clean water interface groove, and thus, the two are matched and docked.

In some embodiments, one of the first positioning part 2222 and the second positioning part 2612 is a positioning protrusion, and the other thereof is a positioning recess. For example, as shown in FIG. 1 to FIG. 7, the first positioning part 2222 is a positioning protrusion. The positioning protrusion extends from the mounting surface 222 and extends away from the mounting surface 222. For example, the positioning protrusion extends from the mounting surface 222 and extends away from the mounting surface 222 in a direction substantially perpendicular to the mounting surface 222. For example, the second positioning part 2612 is a positioning recess provided on the interface surface 261, and concaves from the interface surface 261 to the interior of the clean water tank 26. The positioning protrusion and the positioning recess match each other in shape and size. When the clean water tank 26 is mounted in the mounting groove 221, the positioning protrusion is inserted into the positioning recess, and thus, the two are matched and docked.

In some embodiments, the number of the first positioning part(s) 2222 and the second positioning part(s) 2612 may be one or more, and the two are in one-to-one correspondence.

In some embodiments, the number of the first positioning parts 2222 is, for example, two. The two first positioning parts 2222 are provided on two sides of the first clean water interface part 2221, respectively. For example, the two first positioning parts 2222 are symmetrically provided relative to the center of the first clean water interface part 2221. In a specific example, the mounting surface 222 is, for example, quadrilateral, and the two first positioning parts 2222 are located on a diagonal line of the mounting surface 222. Accordingly, the number of the second positioning parts 2612 is also, for example, two. The two second positioning parts 2612 are provided on two sides of the second clean water interface part 2611, respectively. For example, the two second positioning parts 2612 are symmetrically provided relative to the center of the second clean water interface part 2611. In a specific example, the interface surface 261 is, for example, quadrilateral, and the two second positioning parts 2612 are located on a diagonal line of the interface surface. In such a design, the mounting and positioning of the clean water tank 26 and the mounting groove 221 can be facilitated, and the clean water tank 26 mounted in the mounting groove 221 can be prevented from shaking relative to the apparatus body 22.

In some embodiments, the first clean water interface part 2221 is also located on the diagonal line of the mounting surface 222, and accordingly, the second clean water interface part 2611 is also located on the diagonal line of the interface surface 261.

In some embodiments, as shown in FIG. 1 to FIG. 7, the water outlet of the clean water tank 26 is provided close to the top 262 of the clean water tank 26. Specifically, the distance between the water outlet of the clean water tank 26 and the top 262 of the clean water tank is less than the distance between the water outlet of the clean water tank and the bottom 263 of the clean water tank. For example, a ratio of the distance between the water outlet of the clean water tank 26 and the top 262 of the clean water tank to the distance between the water outlet of the clean water tank and the bottom 263 of the clean water tank is less than ½. In such a configuration, the clean water tank 26 is not susceptible to water leakage.

In some embodiments, the clean water tank 26 further includes an air-intake water blocking valve 264 provided at the top 262 of the clean water tank 26. The air-intake water blocking valve 264 is configured to balance the air pressure between the clean water tank 26 and the outside. The air-intake water blocking valve 264 is configured to allow a gas to enter the clean water tank, and block a liquid (e.g., water) from overflowing from the clean water tank. Since the water outlet of the clean water tank 26 is provided in the vicinity of the top 262 of the clean water tank, water in the clean water tank 26 needs to be pumped out of the clean water tank by an external force, leading to the reduced air pressure in the clean water tank 26. If the air pressure in the clean water tank 26 continues to decrease, it is not conducive to the pumping of the clean water in the clean water tank 26. In this case, the clean water tank may be communicated with the outside to allow external air enters the clean water tank, thereby maintaining stable air pressure in the clean water tank 26. In general, this can be achieved by providing a through hole in the clean water tank, in which case, however, the clean water in the clean water tank is likely to leak from the through hole. Based on this, the air-intake water blocking valve 264 is configured to balance the air pressure between the clean water tank 26 and the outside, such that the clean water can be pumped normally without causing leakage of the clean water.

In some embodiments, the air-intake water bocking valve 264 includes a silicone cross valve, which is simple in structure and low in cost and has excellent air-permeating and water-blocking performances.

In some embodiments, a floater indicating part, for example, a floating ball, may also be provided in the clean water tank 26, and is configured to detect the level of clean water in the clean water tank. For example, the floating ball is provided on the inner bottom surface of the clean water tank. In response to the water level in the clean water tank falling below a predetermined value, the floating ball triggers an alarm device to send an alarm signal, reminding the user to refill the clean water tank with clean water.

In some embodiments, a water pumping tube is provided in the clean water tank 26, and the water pumping tube has one end connected to the water outlet of the clean water tank and the other end provided on the inner bottom surface of the clean water tank 26. In this way, it is ensured that almost all water in the clean water tank can be pumped out.

In the present disclosure, the clean water and the cleaning liquid are also collectively referred to as a cleanout liquid, which is sprayed to the cleaning roller or the surface to be cleaned when the cleaning apparatus performs a wet cleaning operation. The above embodiments are described by taking the clean water tank accommodating the clean water as an example, in which case the clean water may be mixed in the mixing tube with the detergent provided by the detergent tank to form the cleaning liquid, and then the cleaning liquid is sprayed to the cleaning roller or the surface to be cleaned to enable the cleaning apparatus to perform the wet cleaning operation.

In some embodiments, the cleaning apparatus may not include a detergent tank, and only use clean water as the cleanout liquid, and the cleanout liquid is sprayed to the cleaning roller or the surface to be cleaned to enable the cleaning apparatus to perform the wet cleaning operation.

In some embodiments, the clean water tank of the cleaning apparatus may not include a detergent tank, and further accommodate the cleaning liquid. The cleaning liquid is directly used as the cleanout liquid to be sprayed to the cleaning roller or the surface to be cleaned to enable the cleaning apparatus to perform the wet cleaning operation.

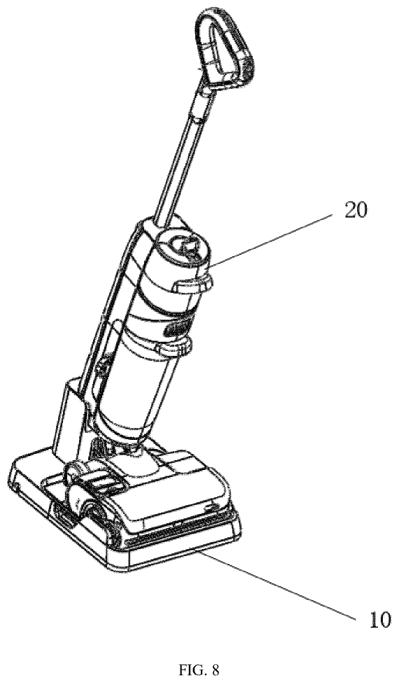

FIG. 8 is a schematic structural diagram of a cleaning system provided according to some embodiments of the present disclosure. As shown in FIG. 8, a cleaning system is provided according to some embodiments of the present disclosure. The cleaning system includes the cleaning apparatus 20 described in the foregoing embodiments and a station 10. The station 10 is configured to support the cleaning apparatus 20. After completing the cleaning work, the cleaning apparatus 20 may be put back to the station 10 for support. A variety of operations may be performed on the station 10, for example, including charging, cleaning the cleaning roller, drying the cleaning roller and the like.

According to some embodiments of the present disclosure, a cleaning apparatus is provided. The cleaning apparatus includes:
a cleaning base provided with a cleaning roller, the cleaning base being configured to move on a surface to be cleaned to enable the cleaning roller to clean the surface to be cleaned;
a clean water tank configured to accommodate clean water;
a detergent tank configured to accommodate a detergent; and
a dual-head pump configured to pump a first liquid and a second liquid, the dual-head pump including:
a first pump body configured to pump the first liquid,
a second pump body configured to pump the second liquid, and
a drive motor for driving the first pump body and the second pump body.

In some embodiments, the first pump is provided on a first side of the drive motor, and the second pump body is provided on a second side of the drive motor.

In some embodiments, the first side is provided opposite to the second side.

In some embodiments, the first liquid and the second liquid are any two of:
the clean water, the detergent, and a mixture of the clean water and the detergent.

In some embodiments, the cleaning apparatus further includes:
a mixing tube, including:
a first inlet, a second inlet and a cleaning liquid outlet;
the mixing tube is configured to mix a liquid flowing from the first inlet and a liquid flowing from the second inlet to generate a cleaning liquid, and to output the cleaning liquid from the cleaning liquid outlet; and
the cleaning liquid is configured to be dispensed through a liquid dispenser to the cleaning roller and/or the surface to be cleaned.

In some embodiments, the clean water and the detergent are mixed in the mixing tube at a predetermined ratio.

In some embodiments, the dual-head pump is provided in the cleaning base.

In some embodiments, the detergent tank is provided in the cleaning base, and the dual-head pump is provided between the detergent tank and a bottom surface of the cleaning base.
In some embodiments, the cleaning apparatus further includes:
a mounting groove, in which the clean water tank is detachably mounted, where the mounting groove has a mounting surface, and a clean water connector and at least one first positioning part are provided on the mounting surface;
the clean water tank has an interface surface, and a clean water port groove and at least one second positioning part are provided on the interface surface; and
when the clean water tank is mounted in the mounting groove, the first positioning part is matched and combined with the second positioning part to prevent the clean water tank from shaking relative to an apparatus body.

In some embodiments, the number of the first positioning parts is two, and the two first positioning parts are provided on two sides of the clean water connector, respectively.

In some embodiments, a water outlet of the clean water tank is provided in the clean water interface groove, and a distance between the water outlet of the clean water tank and a top of the clean water tank is less than a distance between the water outlet of the clean water tank and a bottom of the clean water tank.

In some embodiments, the clean water tank further includes an air-intake water blocking valve provided at a top of the clean water tank.

In some embodiments, the air-intake water bocking valve includes a silicone cross valve.

According to some embodiments of the present disclosure, a cleaning system is provided. The cleaning system includes:
the cleaning apparatus described in the foregoing embodiments; and
a station configured to support the cleaning apparatus.

According to some embodiments of the present disclosure, a cleaning apparatus is further provided. The cleaning apparatus includes:
an apparatus body having a mounting groove; and
a clean water tank detachably mounted in the mounting groove and configured to store a cleaning liquid,
wherein the mounting groove has a mounting surface, and a first clean water interface part and at least one first positioning part are provided on the mounting surface;
the clean water tank has an interface surface, and a second clean water interface part and at least one second positioning part are provided on the interface surface; and
when the clean water tank is mounted in the mounting groove, the first clean water interface part is matched and docked with the second clean water interface part, and the first positioning part is matched and docked with the second positioning part.

In some embodiments, one of the first and second clean water interface parts is a clean water connector, and the other thereof is a clean water interface groove.

In some embodiments, one of the first and second positioning parts is a positioning column, and the other thereof is a positioning hole.

In some embodiments, the number of the first positioning parts is two, and the two first positioning parts are provided on two sides of the first clean water interface part, respectively.

In some embodiments, the mounting surface is quadrilateral and the two first positioning parts are located on a diagonal line of the mounting surface, and the first clean water interface part is located on the diagonal line.

In some embodiments, the distance between the water outlet of the clean water tank and the top of the clean water tank is less than the distance between the water outlet of the clean water tank and the bottom of the clean water tank.

In some embodiments, the clean water tank further includes an air-intake water blocking valve provided at the top of the clean water tank.

In some embodiments, the air-intake water bocking valve includes a silicone cross valve.

In some embodiments, a floater indicating part is provided in the clean water tank, and is configured to detect the level of clean water in the clean water tank.

In some embodiments, a water pumping tube is provided in the clean water tank, and has one end connected to the water outlet of the clean water tank and the other end provided on an inner bottom surface of the clean water tank.

According to some embodiments of the present disclosure, a cleaning system is provided. The cleaning system includes:
the cleaning apparatus described in the foregoing embodiments; and
a station configured to support the cleaning apparatus.

Finally, it should be noted that various embodiments in the Description are described in a progressive manner, each embodiment focuses on the differences from the other embodiments, and the same or similar parts between the various embodiments may refer to each other. The system or device disclosed in the embodiments corresponds to the method disclosed in the embodiments, and thus is described in a relatively simple way, and a reference can be made to the description in the method section for related parts.

The above embodiments are only used to illustrate the technical solutions of the present disclosure, and are not intended to limit the present disclosure. Although the present disclosure has been described in detail with reference to the foregoing embodiments, those of ordinary skill in the art should understand that: they can still make modifications to the technical solutions described in the foregoing embodiments, or make equivalent substitutions to some of the technical features; and these modifications or substitutions do not deviate the essence of the corresponding technical solutions from the spirit and scope of the technical solutions of the respective embodiments of the present disclosure.

1. A cleaning apparatus, comprising:
a cleaning base provided with a cleaning roller, the cleaning base being configured to move on a surface to be cleaned to enable the cleaning roller to clean the surface to be cleaned;
a clean water tank configured to accommodate clean water;
a detergent tank configured to accommodate a detergent; and
a dual-head pump configured to pump a first liquid and a second liquid, the dual-head pump comprising:
a first pump body configured to pump the first liquid,
a second pump body configured to pump the second liquid, and
a drive motor for driving the first pump body and the second pump body.

2. The cleaning apparatus according to claim 1, wherein the first liquid and the second liquid are any two of:
the clean water, the detergent, and a mixture of the clean water and the detergent.

3. The cleaning apparatus according to claim 1, further comprising:
a mixing tube, comprising:
a first inlet, a second inlet and a cleaning liquid outlet, wherein
the mixing tube is configured to mix a liquid flowing from the first inlet and a liquid flowing from the second inlet to generate a cleaning liquid, and to output the cleaning liquid from the cleaning liquid outlet; and
the cleaning liquid is configured to be dispensed through a liquid dispenser to the cleaning roller and/or the surface to be cleaned.

4. The cleaning apparatus according to claim 3, wherein the clean water and the detergent are mixed in the mixing tube at a predetermined ratio.

5. The cleaning apparatus according to claim 1, wherein the dual-head pump is provided in the cleaning base.

6. The cleaning apparatus according to claim 5, wherein the detergent tank is provided in the cleaning base, and the dual-head pump is provided between the detergent tank and a bottom surface of the cleaning base.

7. The cleaning apparatus according to claim 1, further comprising:
a mounting groove, in which the clean water tank is detachably mounted, wherein the mounting groove has a mounting surface, and a first clean water interface part and at least one first positioning part are provided on the mounting surface;
the clean water tank has an interface surface, and a second clean water interface groove part and at least one second positioning part are provided on the interface surface; and
when the clean water tank is mounted in the mounting groove, the first positioning part is matched and combined with the second positioning part to prevent the clean water tank from shaking relative to an apparatus body.

8. The cleaning apparatus according to claim 7, wherein there are two first positioning parts, and the two first positioning parts are provided on two sides of the clean water connector, respectively.

9. The cleaning apparatus according to claim 7, wherein a water outlet of the clean water tank is provided in the clean water interface groove, and a distance between the water outlet of the clean water tank and a top of the clean water tank is less than a distance between the water outlet of the clean water tank and a bottom of the clean water tank.

10. The cleaning apparatus according to claim 1, wherein the clean water tank further comprises an air-intake water blocking valve provided at a top of the clean water tank.

11. The cleaning apparatus according to claim 10, wherein the air-intake water bocking valve comprises a silicone cross valve.

12. A cleaning system, comprising:
the cleaning apparatus according to claim 1; and
a station configured to support the cleaning apparatus.

13. The cleaning apparatus according to claim 1, wherein the first pump is provided on a first side of the drive motor, and the second pump body is provided on a second side of the drive motor.

14. The cleaning apparatus according to claim 13, wherein the first side is provided opposite to the second side.

15. The cleaning apparatus according to claim 7, wherein one of the first clean water interface part and the second clean water interface part is a clean water connector, and the other of the first clean water interface part and the second clean water interface part is a clean water interface groove.

16. The cleaning apparatus according to claim 7, wherein one of the first positioning part and the second positioning part is a positioning column, and the other of the first positioning part and the second positioning part is a positioning hole.

17. The cleaning apparatus according to claim 7, wherein the mounting surface is quadrilateral and the two first positioning parts are located on a diagonal line of the mounting surface, and the first clean water interface part is located on the diagonal line.

18. The cleaning apparatus according to claim 1, wherein a floater indicating part is provided in the clean water tank, and is configured to detect the level of clean water in the clean water tank.

19. The cleaning apparatus according to claim 1, wherein a water pumping tube is provided in the clean water tank, and has one end connected to a water outlet of the clean water tank and the other end provided on an inner bottom surface of the clean water tank.
